(19) United States
(12) Patent Application Publication
(10) Pub. No.: US 2021/0084917 A1
(43) Pub. Date: Mar. 25, 2021

(54) Freeze-Drying Methods

(71) Applicant: Siobhan Reilly, Ponca City, OK (US)

(72) Inventor: Siobhan Reilly, Ponca City, OK (US)

(21) Appl. No.: 16/577,183

(22) Filed: Sep. 20, 2019

(51) Int. Cl. A23B 4/06; A23L 33/135; A23B 7/04

(52) U.S. Cl. CPC A23B 4/06; A23V 2002/00; A23B 7/04; A23L 33/135

(57) ABSTRACT

A method for freeze-drying food products that includes a probiotic composition for the mitigation, inhibition, and/or exclusion of microorganisms.

### TECHNICAL FIELD

The present disclosure provides methods for using probiotics and combinations of probiotics in conjunction with freeze-drying processes in order to reduce or eliminate pathogens. Further provided are methods for controlling pathogens on processed food by utilizing the probiotic composition(s) during food preservation processes, such as freeze-drying.

### BACKGROUND

Freeze-drying, also known as lyophilization or cryodesiccation, is a dehydration process that involves freezing the food product and then removing water from the food product by sublimation. Sublimation is the transition of the water contained in the food product directly from the solid phase to the gas phase without passing through the liquid phase. Freeze-drying is different from other dehydration process, which only use heat to evaporate water. Thus, freeze-drying often results in a high-quality food product because of the lower temperature that is used during processing. Additionally, the original shape of the food product is maintained during freeze-drying and quality of the rehydrated food is better as compared to food treated via. dehydration methods only.

While freeze-drying processes are very commonly used, the fact remains that many freeze-drying processes fail to eliminate or reduce pathogens to an acceptable level. Indeed, the low temperature that is often utilized during freeze-drying may not eliminate all pathogens on the food product. As freeze drying is a form of preservation of food, it also preserves microbial cells (including pathogens). Freeze dried foods may present a greater danger than traditionally preserved foods (smoked, dried, cooked) and subject the public to unaccounted for pathogens. In the food processing industry, the control of contamination by microorganisms is a recognized large problem. Accordingly, the food industry is concerned with preventing contamination of food products with harmful microorganisms during food processing, such as during freeze-drying processes but this is difficult. Indeed, if consumers are exposed to food product containing harmful pathogens, sickness or even death may occur. Thus, food processors have a need for removing and mitigating harmful pathogens on food products.

Eliminating harmful pathogens on food products, especially raw food products such as meats, fruits, and vegetables, can be especially difficult given that the innate microbiome present on the raw food product is largely unknown, For example, there may be different strains of pathogens present on the food product or there may be different amounts of certain strains of pathogens on the food product prior to freeze-drying. Since the amounts and types of pathogens are largely unknown, it is difficult for food manufacturers to find an effective solution to treat these unknown pathogens. This creates a unique problem regarding pathogen control during freeze-drying, since many freeze-dried food products are meats, fruits, and vegetables, Without understanding what types of pathogens are present on the food product, it is difficult if not impossible to completely eliminate or significantly reduce the pathogens present. Accordingly, there exists a need for a freeze-drying method that effectively reduces the overall pathogen load of freeze-dried food products.

Another issue associated with freeze-drying processes is that there can be great variations of procedure, especially on a commercial scale. For example, depending on the temperature and. pressure parameters over time during the freeze-drying process, there may not be a meaningful change in the water activity of the freeze-dried food product. Higher temperature profiles may degrade the quality of the freeze dried food product itself. Thus, given the many variations that may exist in freeze-drying processes, especially those on a commercial scale, it is often difficult to adjust the parameters of the freeze-drying process to eliminate pathogens, while maintaining the desired integrity of the freeze-dried food product.

Thus, provided herein are methods of treating food products with certain combinations of probiotics and freeze-drying the treated food products in order to reduce or eliminate pathogens from freeze-dried food products. Additionally, the probiotic composition(s) disclosed herein is effective at removing and/or significantly reducing the pathogen load of the food product, even when the initial pathogen load is unknown. Furthermore, use of the probiotic compositions disclosed herein are not hazardous to food production equipment, employees, or the food product.

### BRIEF SUMMARY OF THE INVENTION

The disclosure is directed, in one embodiment, to a method for freeze-drying a food product comprising the step of a. coating the food product with a probiotic composition to create a probiotic composition-coated food product and b. subjecting the probiotic composition-coated food product to a suitable freeze-drying process. The probiotic composition includes a population of microorganisms. In certain embodiments, the probiotic composition includes species from the genus Lactobacillus, species from the genus Bifidobacterium, and combinations thereof. The disclosure is also directed to freeze-dried food products containing a probiotic composition.

In some embodiments, the probiotic composition is capable of mitigating pathogenic biofilm on the food product during and/or after the freeze-drying process.

In some embodiments, the probiotic composition inhibits the growth of pathogenic microorganisms on the food product during and/or after the freeze-drying process.

In certain embodiments, the probiotic composition is formulated as an aerosol composition. The application of the probiotic composition in aerosol form to the food product ensures that the probiotic composition adequately coats the entire surface area and all angles of the food product.

Further, provided herein are methods for reducing or eliminating pathogens from freeze-dried food product including the steps of: a. applying or coating food product with the probiotic composition disclosed herein to provide a probiotic composition-coated food product, and b. subjecting the probiotic composition-coated food product to a suitable freeze-drying procedure. In some embodiments, the method for reducing or eliminating pathogens from freeze-dried food product includes inhibiting the growth of certain pathogens, such as Salmonella spp, on food product.

In some embodiments, provided are methods directed to the competitive exclusion of pathogens on a freeze-dried food product that comprises applying and/or coating the food product with the probiotic composition(s) disclosed herein and subjected the probiotic composition-coated food product to freeze-drying.

Also provided are methods for mitigating pathogenic biofilm and the pathogens associated thereon from a freeze-dried food product via coating and/or applying the probiotic composition on the food product and subjecting the probiotic composition-coated food product to freeze-drying.

It is to be understood that both the foregoing general description and the following detailed description present embodiments of the disclosure and are intended to provide an overview or framework for understanding the nature and character of the disclosure as it is claimed. The description serves to explain the principles and operations of the claimed subject matter. Other and further features and advantages of the present disclosure will be readily apparent to those skilled in the art upon a reading of the following disclosure.

### BRIEF DESCRIPTION OF THE DRAWINGS

FIG. 1 illustrates the Salmonella species that are present or absent after chicken has been subjected to a freeze-drying process.

FIG. 2 illustrates the Salmonella species that are present or absent after chicken has been subjected to a freeze-drying process.

FIG. 3 illustrates the Salmonella species that are present or absent after chicken has been subjected to a freeze-drying process.

### DETAILED DESCRIPTION

Reference now will be made in detail to the embodiments of the present disclosure, one or more examples of which are set forth hereinbelow. Each example is provided by way of explanation of the method and/or composition of the present disclosure and is not a limitation. In fact, it will be apparent to those skilled in the art that various modifications and variations can be made to the teachings of the present disclosure without departing from the scope of the disclosure. For instance, features illustrated or described as part of one embodiment, can be used with another embodiment to yield a still further embodiment.

Thus, it is intended that the present disclosure covers such modifications and variations as come within the scope of the appended claims and their equivalents. Other objects, features and aspects of the present disclosure are disclosed in or are apparent from the following detailed description. It is to be understood by one of ordinary skill in the art that the present discussion is a description of exemplary embodiments only and is not intended as limiting the broader aspects of the present disclosure.

As used herein the term “probiotic composition” refers to any microorganism that confer a health benefit on the host. Non-limiting examples of probiotic microorganisms that may be included in the probiotic composition disclosed herein may be from the genus Lactobacillus, Bifidobacterium, Enterococcus, Bacillus, Propionibacterium, and/or Leuconostoc.

As used herein, the term “pathogen” refers to an agent having the capability of producing a disease. For example, a pathogen may refer to a virus, bacterium, or other disease-producing microorganism. For example, the term pathogen may refer to any of the following: Salmonella enterica, Salmonella salamae, Salmonella diarizonae, Salmonella houtenae, Salmonella indica, Salmonella bongori, Enterotoxigenic E. coli (ETEC), Enteropathogenic E. coli (EPEC), Enteroinvasive E. coli (EIEC), Enterohemorrhagic E. coli (EHEC), Uropathogenic E. coli (UPEC), Escherichia coli, Shigella, Clostridium, Campylobacter, Staphylococcus, and/or Listeria.

As used herein, the term “food product” is any food product that may be subjected to freeze-drying or lyophilization. Examples of food product include, but are not limited to the following: chicken, beef, pork, seafood, such as fish, shrimp, crab, lobster, mussels, squid, vegetables, fruit, fruit juice, eggs, dairy, coffee, beans, minerals, mineral supplements, and combinations thereof. In certain embodiments, the food product may include one or more meat products. In certain embodiments, the food product may include one or more vegetables or fruits.

As used herein, the term “freeze-drying” is any process that is used to dry something, i.e. a food product, in a frozen state under vacuum for preservation. Freeze-drying is the removal of ice or other solvents from a material, i.e. a food product, through the process of sublimation and the removal of bound water molecules through the process of desorption. The terms freeze-drying and lyophilization may be used interchangeable herein. Freeze-drying procedures are generally controlled enough to remove the water in a product while avoiding changes in the dried product's appearance and characteristics.

Generally, the steps required to freeze-dry or lyophilize a product, i.e. a food product, in a batch process may include: (1) pretreatment of the product, (2) loading of the product into the freeze-dryer apparatus, (3) freezing of the product, (4) primary drying (sublimation) of the product under vacuum, (5) secondary drying (desorption) of the product under vacuum, (6) backfill and stoppering (for product packaging) under partial vacuum, and (7) removal of the dried product from the freeze-dryer apparatus.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods and compositions of the present disclosure, including components thereof, can comprise, consist of, or consist essentially of the essential elements and limitations of the embodiments described herein, as well as any additional or optional ingredients, components or limitations described herein or otherwise useful in the methods and probiotic compositions disclosed herein.

As used herein, the term “about” should be construed to refer to both of the numbers specified as the endpoint(s) of any range. Any reference to a range should be considered as providing support for any subset within that range.

Generally, there are four stages that are required to complete the freeze-drying process: pretreatment, freezing, primary drying, and secondary drying. While optional, pretreatment includes any method of treating the product prior to freezing. During the freezing stage, the food product is cooled below its triple point. This ensures that sublimation rather than melting will occur in the primary and secondary drying steps. The freezing phase is one of the most important in the freeze-drying process, as the freezing method utilized can influence the speed of reconstitution, duration of the freeze-drying cycle, product stability, and appropriate crystallization of the food product. During the primary drying phase, the pressure is lowered, and enough heat is supplied to the material for the ice contained within the food product to sublimate. During primary drying, anywhere from about 80% to 95% of the water in the food product is sublimated. Primary drying can last anywhere from a few hours to days depending on the shape, size and water content of the food product. The secondary drying phase follows the primary drying phase and is designed to remove any unfrozen water molecules in the food product. Generally, parameters for secondary drying are governed by the material's adsorption isotherms. During secondary drying, the temperature may be raised higher than in the primary drying phase.

One of the biggest disadvantages associated with freeze-drying food products is that freeze-drying alone does not adequately control pathogen and microbial growth on freeze-dried food product. Since the method of preservation for freeze-drying relies on a low temperature dehydration process, spoilage organisms and other pathogens resistant to these conditions can remain alive and viable on the food product. If viable pathogens remain on the food product post freeze-drying, these pathogens can begin to colonize and reproduce during shipping and storage of the freeze-dried food product effectively contaminating or continuing to contaminate the food product. Indeed, the U.S. Food and Drug Administration (“FDA”) linked a multistate outbreak of foodborne hepatitis A to freeze-dried strawberries. Accordingly, inadequate pathogen control in freeze-dried food products is a significant concern for food product manufacturers.

Thus, one embodiment provided herein is a method of freeze-drying a food product that includes the step of a. applying and/or coating the probiotic composition to a food product to provide a probiotic composition-coated food product, and b. subjecting the probiotic composition-coated food product to a freeze-drying process.

In some embodiments, the probiotic composition is applied to the food product prior to subjecting the food product to any step of the freeze-drying process. In some embodiments, the probiotic composition may be applied before primary drying of the freeze-drying process. In some embodiments, the probiotic composition may be applied after primary drying but prior to secondary drying of the freeze-drying process. In some embodiments, the probiotic composition may be applied to the food product after secondary drying of the freeze-drying process. Still in other embodiments, the probiotic composition may be applied to the food product multiple times during the freeze-drying process, i.e. before and/or after either primary drying, secondary drying, or both. For example, in some embodiments the probiotic composition may be applied to the food product prior to primary drying of the freeze-drying process and after completion of secondary drying.

In some embodiments, the freeze-drying process of the food product containing the probiotic compositions is subjected to the freeze-drying procedure from 1 hour to 240 hours. In certain embodiments, the freeze-drying process is conducted at a surrounding atmosphere temperature of from about −80° F. to about 400° F. at a direct food-product contact surface temperature of about −40° F. to about 300° F. In some embodiments, the freeze-drying process is conducted at a pressure of about 10⁻¹² mbar. It is to be understood, that any freeze-drying process and corresponding time and temperature profile may be used according to the example embodiments provided herein.

In some embodiments, the probiotic composition is applied to the food product in an amount of from about 1×10² CFU per gram of food product to about 1×10¹¹ per gram of food product. In some embodiments, the probiotic composition is applied to the food product in an amount of from about 1×10³ CFU per gram of food product to about 1×10⁹ per gram of food product. In some embodiments, the probiotic composition is applied to the food product in an amount of from about 1×10⁵ CFU per gram of food product to about 1×10⁷ per gram of food product. In some embodiments, the probiotic composition is applied to the food product in an amount of from about 1×10⁶ CFU per gram of food product to about 1×10⁹ per gram of food product. In some embodiments, the probiotic composition is applied to the food product in an amount of from about 1×10⁹ CFU per gram of food product to about 1×10¹¹ per gram of food product.

In some embodiments, the probiotic composition includes from about 1×10² CFUs to about 1×10¹¹ CFUs of probiotic bacteria per gram of finished probiotic composition product. In some embodiments, the probiotic composition includes from about 1×10⁵ CFUs to about 1×10¹¹ CFUs of probiotic bacteria per gram of finished probiotic composition product. in some embodiments, the probiotic composition includes from about 1×10⁵ CFUs to about 1×10⁹ CFUs of probiotic bacteria per gram of finished probiotic composition product.

In some embodiments, the probiotic composition may be applied to the food product in any suitable manner known in the art. Examples include, but are not limited to, sprinkling a powdered form of the probiotic composition evenly over the food product, spraying an aerosol form of the probiotic composition evenly over the food product, spraying a liquid form of the probiotic composition evenly over the food product, and/or any combination thereof. In some embodiments, the food product is placed directly in a container containing the probiotic composition and is mixed in the probiotic composition to ensure that the probiotic composition coats the entire outer surface of the food product. In these ernbodiments, the probiotic composition in the container may be in powdered or liquid form to ensure that the probiotic composition evenly coats the entire surface of the food product. In some embodiments, the probiotic composition is applied to the food product in a manner such that it is blended throughout the food matrix,

In some embodiments, after the food product is adequately coatedwith the probiotic, composition, it may be placed on trays or other suitable apparatus and inserted into the freeze-dryer. Still in other embodiments, the probiotic composition may be applied to the food product while it is in the freeze-dryer. In these embodiments, the probiotic composition may be in aerosol form and sprayed on to the food product that is located within the freeze-dryer. This method of applying the probiotic composition to the food product while it is in the freeze-dryer may have the added advantage of reducing pathogens and the overall pathogen load that is located on the inside of the freeze-dryer and on the trays that hold the food product in the freeze-dryer. Further, in these embodiments the aerosolized application of the probiotic composition to the food product ensures even, multidirectional delivery of the probiotic composition to the food product.

In some embodiments, the probiotic composition contains at least one of and any bination of the following microorganisms: Lactobacillus acidophilus, Lactobacillus casei, Lactobacillus paracasei, Lactobacillus fermentum, Lactobacillus lactis, Lactobacillus reuterii, Lactobacillus rhamnoses, Lactobacillus bulgaricus, Lactobacillus plantarum, Lactobacillus salivarius, Lactobacillus delbrueckii, Lactobacillus helveticus, Lactobacillus brevis, Lactobacillus sakei, Lactobacillus johnsonii, Bifidobacterium longum, Bifidobacterium bifidum, Bifidobacterium breve, Bifidobacterium infantis, Bifidobacterium adolecentis, Bifidobacterium lactis, Bifidobacterium animalis, Enterococcus faecium, Enterococcus, Pediococcus, Leuconostoc, Streptococcus, and combinations thereof.

In some embodiments, the probiotic composition comprises Lactobacillus acidophilus, and at least one microorganism selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus acidophilus, and at least two microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus acidophilus, and at least three microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis.

In some embodiments, the probiotic composition cot. Lactobacillusprises aciclophilus, Enterococcus faecium, and at least one microorganism selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus acidophilus, Enterococcus fileciuin, and at least two microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments the probiotic composition comprises Lactobacillus acidophilus, Enterococcus faecium, and at least three microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis.

In some embodiments, the probiotic composition comprises Lactobacillus casei and at least one microorganism selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus casei and at least two microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis.

In some embodiments, the probiotic composition comprises Lactobacillus paracasei and at least one microorganism selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some bodiments, the probiotic composition comprises Lactobacillus paracasei and at least two microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus paracasei and at least three microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis.

In some embodiments, the probiotic composition comprises Lactobacillus fermentum and at least one microorganism selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus fermentum and at least two microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus fermentum and at least three microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis.

In some embodiments the probiotic composition comprises Lactobacillus lactis and at least one microorganism selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus lactis and at least two microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus lactis and at least tti o microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis.

In some embodiments, the probiotic composition comprises Lactobacillus reuterii and at least one microorganism selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus reuterii and at least two microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus reuterii and at least three microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis.

In some embodiments, the probiotic composition comprises Lactobacillus rhamnoses and at least one microorganism selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus rhamnoses and at least two microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus rhamnoses and at least three microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis.

In some embodiments, the probiotic composition comprises Lactobacillus bulgaricus and at least one microorganism selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus bulgaricus and at least two microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus bulgaricus and at least three microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis.

In some embodiments, the probiotic composition comprises Lactobacillus plantarum and at least one microorganism selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus plantarum and at least two microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus plantarum and at least three microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis.

In some embodiments, the probiotic composition comprises Lactobacillus salivarius and at least one microorganism selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus salivarius and at least two microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus salivarius and at least three microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis.

In some embodiments, the probiotic composition comprises Lactobacillus delbrueckii and at least one microorganism selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus delbrueckii and at least two microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus delbrueckii and at least three microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis.

In some embodiments, the probiotic composition comprises Lactobacillus helveticus and at least one microorganism selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus helveticus and at least two microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus helveticus and at least three microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis.

In some embodiments, the probiotic composition comprises Lactobacillus brevis and at least one microorganism selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus brevis and at least two microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus brevis and at least three microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis.

In some embodiments, the probiotic composition comprises Lactobacillus sakei and at least one microorganism selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus sakei and at least two microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus sakei and at least three microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis.

In some embodiments, the probiotic composition comprises Lactobacillus johnsonii and at least one microorganism selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus johnsonii and at least two microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis. In some embodiments, the probiotic composition comprises Lactobacillus johnsonii and at least three microorganisms selected from the following Bifidobacterium longum, Bifidobacterium bifidum, Bifidobacterium breve, Bifidobacterium infantis, Bifidobacterium adolecentis, Bifidobacterium lactis, and Bifidobacterium animalis.

In some embodiments, the probiotic composition may be formulated to contain one or more Lactobacillus species and one or more Bifidobacterium species. In certain embodiments, the probiotic composition may be formulated to include a certain CFU ratio of Lactobacillus species to Bifidobacterium species. For example, in some embodiments the CFU ratio of Bifidobacterium species to Lactobacillus species is from about 1:1 to about 1:4. In some embodiments, the CFU ratio of Bifidobacterium species to Lactobacillus species is from about 1:2.5.

In some embodiments, the probiotic composition may contain the following microorganisms: Bifidobacterium lactis, L. acidophilus, L. casei, and L. reuteri. In some embodiments, the probiotic composition comprises Bifidobacterium lactis, L. acidophilus, L. casei, and L. reuteri in a CFU ratio of 1:1:1:0.1.

Without being bound by any particular theory, the probiotic composition may reduce or eliminate pathogens by producing biosurfactant. Generally, a. biosurfactant is an amphiphilic material, i.e. lipid or a derivative thereof, present in a living body which includes a hydrophilic moiety and a hydrophobic moiety in a single molecule. Biosurfactant is used as a comprehensive term including all surfactants derived from living organisms. Herein, where specified, the biosurfactant in association with the term biosurfa.ctant-producing microorganism, refers to one or more surfactants produced by microorganisms. Certain biosurfactants may have lower toxicity and higher biodegradability than conventional synthetic surfactants. Biosurfactants can be used for highly specific purposes due to their complex chemical structures and they are not easily synthesized by conventional methods. Additionally, biosurfactants are very useful since they have similar physical and chemical effects to chemically synthesized surfactants such as surface tension reduction and temperature and pH stability enhancement.

Accordingly, in certain embodiments the probiotic composition may include at least one biosurfactant-producing microorganism. The biosurfactant-producing microorganism nay be any microorganism or microbe known to produce biosurfactants, in particular embodiments disclosed herein, the at least one biosurfactant-producing microorganism is from the genus Lactobacillus and may be selected from a human sour, animal host sources, or mixtures thereof. In some embodiments the at least one biosurfactant-producing microorganism may be selected from the following: Lactobacillus acidophilus, Lactobacillus casei, Lactobacillus paracasei, Lactobacillus fermentum, Lactobacillus lactis, Lactobacillus reuterii, Lactobacillus rhamnoses, Lactobacillus bulgaricus, Lactobacillus plantarum, Lactobacillus salivarius, Lactobacillus delbrueckii, Lactobacillus Lactobacillus helveticus, Lactobacillus salivarius, Lactobacillus brevis, Lactobacillus sakei, Lactobacillus johnsonii, Bifidobacterium longum, Bifidobacterium bifidum, Bifidobacterium breve, Bifidobacterium infantis, Bifidobacterium adolecentis, Bifidobacterium lactis, Bifidobacterium animalis, Enterococcus faecium, and combinations thereof.

In some embodiments, the biosurfactant-producing microorganism may be a strain of microorganisms known to produce biosurfactants in improved yields. For example, many species of Bacillus produce biosurfactants, however, Bacillus subtilis and Bacillus licheniformis are known to produce significant quantities of biosurfactants. Furthermore,specific strains of Bacillus subtilis are known to produce improved yields of biosurfactants such as B. subtilis ATCC 2133 1. B. subtilis ATCC 21332, B. subtilis SD901. (TERM BP. 7666), B. Subitilis NRRL B-3383 and B. subtilis RSA-203 or mixtures thereof. Many strains of biosurfactant-producing microorganisms may be commerciallyor publicly available. In some embodiments, the at least one biosurfactant-producing microorganism is B. subtilis strain RSA-203. B. subtilis strain RSA-203 s a microorganism that is a strain of Bacillus subtilis. B. subtilis strain is a rod-shaped, aerobic, Gram-positive, β-hemolytic microbe capable of forming endospores.

Without being bound by any particular theory, in certain embodiments the biosurfactant-producing microorganism may dispose a biosurfactant on the pathogenic biofilm of the food product and the biosurfactant may act to remove unforeseen pathogenic biofilms.

In some embodiments, where the probiotic composition includes at least one biosurfactant-producing microorganism, the biosurfactant produced by the microorganism may alter the surface tension of the pathogenic biofilm existing on the surface of the food product to which the biosurfactant-producing microorganisms applied. As such, the biosurfactant produced by the biosurfactant-producing microorganismallows for the dispersion of built-up pathogenic biofilm existing on the surface of the food product. Furthermore, without being bound by any particular theory,application of the at least one biosurfactant-producing microorganism that alters the surface tension of the pathogenic biofilm promotes wetting at the surface of the pathogenic biofilm, thus allowing for dispersion/removal of the pathogenic biofilm. Additionally, the biosurfactant-producing microorganism that acts to change the surface tension of the pathogenic biofilm may prevent additional pathogen adherence to the surface of the biofilm, while dispersing the pathogenic biofilm from the surface of the food product.

In certain embodiments, the probiotic composition includes at least one antiadhesion-producing microorganism. While the at least one antiadhesion-producing microorganism may be any microorganism or microbe known to produce an antiadhesion composition, such as an exopolysaccharide, in some embodiments disclosed herein, the at least one antiadhesion-producing microorganism is selected from Bifidobacterium longum, Bifidobacterium bifidum, Bifidobacterium breve, Bifidobacterium infantis, Bifidobacterium adolecentis, Bifidobacterium lactis, Bifidobacterium animalis, Lactobacillus acidophilus, Lactobacillus casei, Lactobacillus paracasei, Lactobacillus fermentum, Lactobacillus lactis, Lactobacillus reuterii, Lactobacillus rhamnoses, Lactobacillus bulgaricus, Lactobacillus plantarum, Lactobacillus salivarius, Lactobacillus delbrueckii, Lactobacillus helveticus, Lactobacillus brevis, Lactobacillus sakei, Lactobacillus johnsonii, and combinations thereof.

In certain embodiments, the antiadhesion-producing microorganism may be one that produces increased amounts of an antiadhesion substance, such as an exopolysaccharide, in comparison with other antiadhesion-producing microorganisms.

In some embodiments, the antiadhesion-producing microorganism comprises a mixture of suitable antiadhesion-producing, microorganisms. In these embodiments, where the antiadhesion-producing microorganism contains a mixture of microorganisms, the ratio and/or amounts of each included microorganism may be adjusted to determine the overall amount of antiadhesion material produced. In some embodiments where the antiadhesion-producing microorganism contains a mixture of microorganisms, the ratio and/or amounts of each included microorganism may be adjusted to produce a desired antiadhesion composition profile including certain amounts of antiadhesion compositions having different physical and chemical properties.

Without being bound by any particular theory, in some embodiments the antiadhesion-producing microorganism acts to prevent the pathogen from producing cellular factors that promote the pathogen's adherence on the surface of the food product. For example, in some embodiments, the antiadhesion-producing microorganism may act to downregulate genetic expression of adhesion molecules produced by the pathogen.

Thus, without being bound by any particular theory, in certain embodiments where the probiotic composition comprises both a biosurfactant-producing microorganism and an antiadhesion-producing microorganism, the antiadhesion-producing microorganism prevents the existing pathogen from producing adhesion factors in the biofilm while the biosurfactant-producing composition begins to mitigate and disperse the existing pathogenic biofilm from the food product.

In certain embodiments, the probiotic composition includes one or more biofilm-producing microorganisms. In some embodiments, the probiotic composition comprises a biofilm-producing microorganism that is a primary biofilm-producing microorganism, i.e. one that is capable of forming biofilm that adheres to clean surfaces. In some embodiments, the probiotic composition comprises a biofilm-producing microorganism that is a secondary producing microorga i.e. one that produces a biofilm capable of adhering to other biofilms, such as those produced by the primary biofilm-producing microorganism or those produced by pathogenic organisms. As such. in some embodiments, the probiotic composition comprises one or more primary biofilm-forming microorganisms and one or more secondary biofilm-forming microorganisms.

In some embodiments, the biofilm-producing microorganism may be selected such that it is the same microorganism as the biosurfactant-producing microorganism or the bioadhesion-producing microorganism.

While the at least one biofilm-producing microorganism may be any microorganism or microbe known to produce biofilm, in some embodiments disclosed herein, the at least one biofilm-producing microorganism is selected from the following: Bifidobacterium longum, Bifidobacterium bifidum, Bifidobacterium breve, Bifidobacterium infantis, Bifidobacterium adolecentis, Bifidobacterium lactis, Bifidobacterium animalis, Lactobacillus acidophilus, Lactobacillus casei, Lactobacillus paracasei, Lactobacillus fermentum, Lactobacillus lactis, Lactobacillus reuterii, Lactobacillus rhamnoses, Lactobacillus bulgaricus, Lactobacillus plantarum, Lactobacillus salivarius, Lactobacillus delbrueckii, Lactobacillus Lactobacillus helveticus, Lactobacillus salivarius, Lactobacillus brevis, Lactobacillus sakei, Lactobacillus johnsonii, and combinations thereof. In certain embodiments, the biofilm-producing microorganism may be one that produces increased amounts of biofilm in comparison with other biofilm-producing microorganisms

In some embodiments, the biofilm-producing microorganism comprises a mixture of suitable biofilm-producing microorganisirs, In these embodiments, where the biofilm-producing microorganism contains a mixture of microorganisms, the ratio and/or amounts of each of the included microorganisms may be adjusted to determine the overall amount of biofilm produced. In some embodiments where the biofilm-producing microorganism contains a mixture of microorganisms, the ratio and/or amounts of each included microorganism may be adjusted to produce a desired biofilm profile including certain amounts of biofilms haying different physical and chemical properties.

In some embodiments, the selected biosurfactant-producing microorganism may be capable of producing an antiadhesion substance and thus. is also an antiadhesion-producing microorganism. In some embodiments, the biofilm-producing microorganism may be capable of producing an antiadhesion substance and thus, is also an antiadhesion-producing microorganism. Indeed, in some embodiments a microorganism is selected that is capable of being the biosurfactant-producing microorganism. the antiadhesion-producing microorganism, and/or the biofilm-producing microorganism.

In certain embodiments the biosurfactant-producing microorganism, antiadhesion-producing microorganism, and the biofilm-producing organism may all commensally exist on the food product thereby preventing any further infection from harmful pathogens. For example, in embodiments where the probiotic composition is applied to a food product, the biosurfactanty producing microorganism, bioadhesion-producing microorganism, and biofilm-producing microorganism may be applied simultaneously to the food product and each are capable of surviving and exerting certain effects on the pathogenic biofilm and associated pathogens thereon. Indeed, application of the probiotic composition disclosed herein, allows for both mitigation of the pathogenic biofilm and mitigation of the pathogen via suitable mechanisms.

In some embodiments, the probiotic composition may include any suitable fillers or other ingredients such as nonfat dry milk, maltodextrin, corn starch, asparagus powder, rice flour, chicory powder, artichoke powder, butternut squash powder, carrot powder, pumpkin powder, sweet potato powder, beet powder, garlic powder, onion powder, leek powder, potato powder, pea powder, barley flour, soy powder, silicate powder, silica powder, and combinations thereof.

In some embodiments, the probiotic composition may further include one or more prebiotics. In some embodiments, the probiotic composition may include prebiotic material.

In certain embodiments, the probiotic composition may include only selected microorganisms and other ingredients that have been approved by the United States Food and Drug Administration (“USFDA” or “FDA”) and are Generally Recognized as Safe (“GRAS”). Accordingly, in embodiments where the probiotic composition is formulated to only include GRAS ingredients, the probiotic composition may be most suited for direct application on the food product, given that the probiotic composition will not contaminate the freeze-dried food product produced.

In some embodiments, the probiotic composition(s) disclosed herein may be in any form known in the art. For example, the probiotic composition may be in liquid, foam, or powdered form.

In some embodiments, the probiotic composition may be provided in an aerosol form. Generally, aerosol dispensers have been commonly used to dispense personal, household, industrial, and medical products, and to provide a low cost, easy to use method of dispensing a powdered and/or liquid product. Typically, aerosol dispensers include a container, which contains a product to be dispensed. A propellant is used to discharge the product from the container. Accordingly, in some embodiments, the probiotic composition may be in an aerosol form, capable of being dispensed from any suitable aerosol container known in the art.

Indeed, in certain methods disclosed herein, dispensing the probiotic composition in aerosol form may provide additional benefits not previously contemplated. Providing the probiotic composition in aerosol form allows for multi-directional application of the probiotic composition on the desired surface of the food product.

In some embodiments, the probiotic composition may be formulated as a dry, powder blend composition. In certain embodiments, the probiotic composition is a dry blend powder that is ready to use without any additional mixing, agitation, foaming, or liquefying. In certain embodiments, the dry blend powder probiotic composition can be used without any water, alcohol, or other chemical solution for distribution. In some embodiments, the dry blend powder including probiotic composition disclosed herein may be hand distributed to the desired food product. In some embodiments, the food product may be dispersed in the dry blend powder including the probiotic composition and mixed in any suitable manner in order to ensure effective and even coating of the food product in the probiotic composition.

In sonic embodiments described herein, the probiotic composition is produced and manufactured in compliance with current Good Manufacturing Practice as specified in 21 C.F.R. §110.

In some embodiments, provided herein are methods for reducing contamination of food product subjected to a freeze-drying process. The method includes applying and/or coating the food product with the probiotic composition disclosed herein and subjecting the food product coated with the probiotic composition to a freeze-drying process.

In some embodiments, provided herein are methods for mitigating and/or dispersing pathogenic biofilm on the surface of a food product. The method includes applying and/or coating the probiotic composition disclosed herein to the food product and subjecting the food product coated with the probiotic composition to a suitable freeze-drying process.

In some embodiments, provided herein are methods for inducing the competitive inhibition of pathogens on the surface of a food product. The method includes applying and/or coating the probiotic composition disclosed herein to the surface of the food product and subjecting the food product coated with the probiotic composition to a suitable freeze-drying process.

In some embodiments, provided herein are methods for inducing the competitive exclusion of pathogens on the surface of a food product. The method includes applying and/or coating the probiotic composition disclosed herein on the surface of the food product and subjecting the food product coated with the probiotic composition to a suitable freeze-drying process.

In some embodiments, provided herein are methods for controlling the colonization of microorganisms on the surface of a food product. The method includes applying and/or coating the probiotic composition disclosed herein on the surface of the food product and subjecting the food product coated with the probiotic composition to a suitable freeze-drying process.

In some embodiments, provided herein are methods for controlling the microbiome on the surface of a food product during storage and shipment of the food product. As used in this embodiment, “controlling the microbiome” can mean reducing and/or eliminating pathogen colonization on the surface of the food product or promoting the growth and/or colonization of certain microorganisms, such as probiotic microorganisms, on the surface of the food product. The method includes applying and/or coating the probiotic composition disclosed herein on the surface of the food product and subjecting the food product coated with the probiotic composition to a suitable freeze-drying process. In some embodiments, the microbiome on the surface of the food product may be controlled during the entire shelf-life of the food product.

in some embodiments, the methods herein comprise the step of applying the probiotic composition on a food product having a pathogenic biofilm thereon to mitigate and/or disperse the pathogenic biofilm from the surface of the food product. Indeed, application of the probiotic composition as disclosed herein followed by a suitable freeze-drying procedure provides for the removal of pathogenic biofilms from food product surfaces.

Indeed, application of the probiotic composition disclosed herein on a food product, may mitigate pathogenic biofilm on the food product and further, may serve to competitively exclude pathogens on the surface of the food product after the freeze-drying procedure. Accordingly, the food product that has been coated with the probiotic composition disclosed hereinand subjected to a suitable freeze drying process does not re-grow or become re-contaminated with pathogens during subsequent shipment and storage of the food product. Indeed, as shown herein, the probiotic composition is able to eradicate any existing pathogens on the food product and prevent contamination or recontamination of the food product under normal storage conditions, i.e. room temperature storage, up to thirty-five (35) days post freeze-drying. Accordingly, the freeze-dried food product coated with the probiotic composition disclosed herein resists re-contamination or re-infection with pathogens during shipping and storage conditions.

In some embodiments, the methods herein comprise the step of a. applying, coating, and/or disposing the probiotic composition on a food product and b. subjecting the food product having the probiotic composition applied thereto to a freeze-drying procedure in order o inhibit or exclude the growth and colonization of certain pathogens. Indeed, the application of the probiotic composition and subsequent exposure of the probiotic composition-coated food product to a suitable freeze-drying process as disclosed herein may provide competitive inhibition of certain pathogens present on the food product. In some embodiments, application of the probiotic composition on the food product and subsequent freeze-drying of the probiotic composition-coated food product may competitively exclude pathogens.

Further, given the variety of raw meats, vegetables, fruits, and other perishable food products that are placed into freeze-dryers, the inside of the freeze-dryer or the trays that hold the food product in the freeze-dryer may also be contaminated with pathogens. Accordingly, application of the probiotic composition to the food product may inhibit or exclude the growth of harmful pathogens located on the interior of the freeze-dryer from contaminating the food product. Indeed, in certain embodiments, the probiotic composition is formulated to include a biosurfactant-producing probiotic in combination with an anti adhesion-producing microorganism and a bio-film producing microorganism, In these embodiments, without being bound by any particular theory, the antiadhesion-producing microorganism is capable of altering the existing pathogens ability to continue to produce biofilm. While, the biofilm-producing organism may adhere to the food product contact surface and establish a new beneficial microorganism ecosystem on the food product surface. Accordingly, the probiotic composition may prevent contamination of the food product from pathogens that are located inside the freeze-dryer or on the trays or other equipment within the freeze-dryer.

Further, after application of the probiotic composition disclosed herein and application of the freeze-drying process, the probiotic composition may develop its own biofilm and colonize on the food product to which it is applied. The adherence and colonization of the probiotic composition on the food product itself may further prevent or inhibit pathogens from re-establishing on the food product during subsequent storage of the food product. Additionally, the colonization of the probiotic composition on the food product may provide additional health benefits to the consumer. Accordingly, in certain embodiments, application and use of the probiotic compositions) disclosed herein in conjunction with freeze-drying allows for control of the microorganism biofilm the surface of the food product itself, which prevents spoilage and pathogenic contamination of the food product. Indeed, application and use of the probiotic composition(s) in conjunction with freeze-drying eliminates and/or significantly reduces harmful pathogens on the food product as compared to freeze-drying alone without the probiotic composition. This, complete eradication and/or elimination of pathogens on freeze-dried food products would save food production facilities substantial amounts of time and money.

### EXAMPLES

The Examples below illustrate the use of a probiotic composition in accordance with the disclosure herein to remediate pathogens on freeze-dried food products.

### EXAMPLE

Example 1 below illustrates pathogen control exhibited by t probiotic composition in conjunction with a freeze-drying procedure.

Inoculum Preparation: Five Salmonella strains (S. typhimurium ATCC 14028, S. heidelberg ATCC 8326 (formerly S. choleraesuis), S. schwarzengrund, S. infantis^{A}, and S. infantis^{B}) were separately grown in Brain Heart Infusion broth (BHI) (1). Strains were incubated at 35° C. for 24 hours. After incubation, the 5 different strains were mixed, centrifuged (2) (30 minutes at 3900 rpm) and rinsed twice with Butterfield's Phosphate Buffer Diluent (PBD) (3). Cells pellet were re-suspended in a small amount of PBD, then diluted and plated in Xylose-Lysine-Deoxycholate (XLD) (4) agar and incubated aerobically at 35° C. for 24 hours. The cells pellet was added into the ground chicken (target concentration 2.2 CFU/g). The ground chicken was divided in two parts, one part was treated with wet Pre-Liminate™ probiotic formula W41 (target concentration 10⁷ CFU/g). The batch treated with probiotics was dyed blue and the untreated batch was dyed red, both by using diluted food coloring (5). Both batches were put in different trays and frozen at −4° F. overnight.

Sample Preparation: The ground chicken treatments were frozen in trays overnight at −4° F. The frozen ground chicken was cut into cubes of 1⅛-inch length, by ⅝-inch width, by ⅝-inch depth. The frozen ground chicken cubes were stored at −4° F. in Whirl-Pak® bags. Approximately 250 g of chicken cubes were stored in each bag.

Freeze Drying Process: The freeze drying was carried out in the Harvest Right™ Scientific Freeze Dryer Medium model (6). The medium size model has 4 trays with a product capacity of 1-2 gallons of material per batch (6). Approximately 250 g of frozen ground chicken cubes of each treatment were placed in random order in each tray (approximately 500 g of chicken cubes per tray, and 2000 g of chicken cubes per batch). To monitor the temperature during freeze drying one Madge Tech HiTemp140 coil data logger was placed in the middle of each tray, and one Madge Tech HiTemp140 spike data logger was placed in the middle of a chicken cube in each tray (7). The temperature of the freeze dryer was set at 32° F. two hours before to start the freeze-drying process. The temperature profile started at 32° F. Once the samples were loaded, the vacuum was applied. After approximately 30 minutes the vacuum reached <500 mTorr, corresponding to a temperature of 0±3° F. Then, the temperature was increased to 40° F. in approximately 10 minutes using a ramp rate of 4.1° F./min, low vacuum limit of 500 mTorr, and high vacuum limit of 750 mTorr. As soon as the equipment reached 40° F., the ramp rate was changed to 0.1° F./min, low vacuum limit to 650 mTorr, and high vacuum limit to 4000 mTorr. The temperature increased from 40° F. to 160° F. in 20 hours. Once the equipment reached 160° F., the freeze-drying program was ended.

Sample Analysis: The freeze-dried product (with and without probiotics) were immediately collected and partitioned into appropriate treatment combinations. The weights of the product were measured both before and after freeze drying to calculate approximate weight loss. Percent (%) moisture and water activity (aw) were calculated for samples collected from each tray following TEM-LB-21 (8) & WKI-OP-07.25 (9) respectively. The remaining samples were bagged, labeled & stored at room temperature (73° F.) to be processed on Day 1, 3, 5, 7, 10, 14, 21, 28 & 35. Three individual samples for each treatment combination were separately enriched for Salmonella indicators (X-Test) by TEM-LB-20 (10) and Salmonella-PCR by TEM-LB-13 (11), in addition to quantification both probiotics and Salmonella numbers by TEM-LB-06 (12) and BAM chapter 5 (4) respectively.

Pathogen and probiotic concentration for each sample was checked at days, 0-35 at previously stated intervals. Response variables included enrichment and for Salmonella spp. (present or absent), total probiotic organisms that survived in CFU/grams; Salmonella spp. in CFU/grams; and water activity (a_{w}). This experiment was repeated in three separate and independent replications. All replications were performed on different days. The results of each replication are provided below herein. Samples for each replication were distributed within the freeze dryer in a completely randomized treatment design to account for variability within freeze dryer.

Replication 1: Samples of raw chicken product were inoculated with Salmonella (approximately 2-5 cfu/g). Of those, three (3) raw were aseptically collected and tested for total probiotic composition (CFU/g) prior to subjecting the samples to a freeze-drying process (raw samples). Concentrations of probiotic (before freeze drying/raw) were determined to be approximately 1.2×10⁷ CFU per gram of raw chicken product. Table 1 illustrates the variability of water activity (a_{w}) and percent (%) moisture of the samples taken right after freeze-drying (Day 1).

TABLE 1

| | Sample | Water | Moisture |
|---|---|---|---|
| Sample ID | Description | Activity (a_{w}) | (%) |
| Ground Chicken + Prob + Salm | Top Tray | 0.06 | 0.40 |
| Ground Chicken + Prob + Salm | Middle Up Tray | 0.04 | 0.32 |
| Ground Chicken + Prob + Salm | Middle Down Tray | 0.05 | 0.9 |
| Ground Chicken + Prob + Salm | Bottom Tray | 0.12 | 2.45 |
| Ground Chicken + Salm | Top Tray | 0.03 | 0.33 |
| Ground Chicken + Salm | Middle Up Tray | 0.04 | 0.3 |
| Ground Chicken + Salm | Middle Down Tray | 0.04 | 0.8 |
| Ground Chicken + Salm | Bottom Tray | 0.09 | 1.7 |

Table 2 illustrates the numbers of the probiotic organisms present after the freeze-drying procedure (at Day 1-35, at appropriate intervals) and the logio reduction of probiotic organisms at those times.

TABLE 2

| | | | | Total probiotic | |
|---|---|---|---|---|---|
| Storage | Salmonella | | | organisms | Log₁₀ |
| Time | PCR¹ | X-Test | Sample | after freeze- | reduction |
| (DAY) | Positives | (Black) | Description | drying (CFU/g) | (CFU/g) |
| 1 | 1 | 1 | Chicken + Probiotic | 6.2 × 10⁵ | 1.29 |
| | | | + Salmonella | | |
| 1 | 2 | 2 | Chicken + Salmonella | — | — |
| 3 | 1 | 1 | Chicken + Probiotic | 5.9 × 10⁵ | 1.31 |
| | | | + Salmonella | | |
| 3 | 3 | 3 | Chicken + Salmonella | — | — |
| 5 | 1 | 1 | Chicken + Probiotic | 1.1 × 10⁵ | 2.04 |
| | | | + Salmonella | | |
| 5 | 2 | 3 | Chicken + Salmonella | — | — |
| 7 | 0 | 0 | Chicken + Probiotic | 2.8 × 10⁵ | 1.63 |
| | | | + Salmonella | | |
| 7 | 2 | 2 | Chicken + Salmonella | — | — |
| 10 | 0 | 0 | Chicken + Probiotic | 5.2 × 10⁵ | 1.36 |
| | | | + Salmonella | | |
| 10 | 0 | 0 | Chicken + Salmonella | — | — |
| 14 | 0 | 0 | Chicken + Probiotic | 3.3 × 10⁵ | 1.56 |
| | | | + Salmonella | | |
| 14 | 2 | 2 | Chicken + Salmonella | — | — |
| 21 | 0 | 0 | Chicken + Probiotic | 3.1 × 10⁵ | 1.59 |
| | | | + Salmonella | | |
| 21 | 2 | 2 | Chicken + Salmonella | — | — |
| 28 | 0 | 0 | Chicken + Probiotic | 3.7 × 10⁵ | 1.51 |
| | | | + Salmonella | | |
| 28 | 1 | 1 | Chicken + Salmonella | — | — |
| 35 | 0 | 0 | Chicken + Probiotic | 4.1 × 10⁵ | 1.47 |
| | | | + Salmonella | | |
| 35 | 2 | 2 | Chicken + Salmonella | — | — |

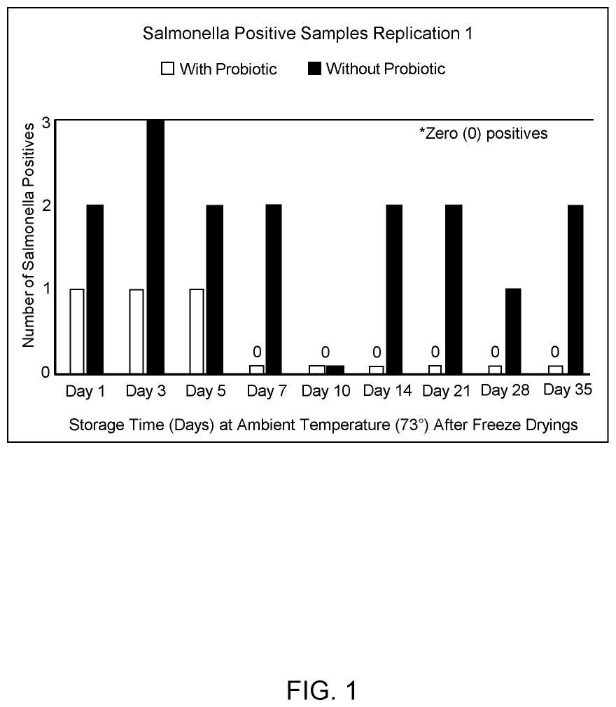

As shown in FIG. 1, on starting on Day 1, the treatment combinations that contained probiotic organisms had fewer or no positives compared to the treatment with no probiotic. On Day 1, only one of the samples inoculated with both the Salmonella and probiotic composition tested positive for Salmonella, in contrast two of the three samples inoculated with Salmonella only (i.e. no probiotic composition) tested positive for Salmonella. Further, this trend continued until Day 7. At Day 7, none of the samples treated with the probiotic composition tested positive for Salmonella. This trend continued for the next 35 days. (See FIG. 1). The control samples containing only Salmonella continued to test positive up to Day 35, whereas the samples treated with the probiotic composition did not test positive for Salmonella starting at Day 7 and continuing throughout Day 35.

Replication 2: Samples of raw chicken product were inoculated with Salmonella. Of those samples, three (3) were selected and tested for total probiotic composition (CFU/g) in the raw product (before freeze drying). The probiotic composition was applied in an amount of 1.1×10⁷ CFU/gram of raw chicken product. The remaining product was then subjected to a freeze-drying process. Table 3 illustrates the water activity (aw) and moisture (%) of the samples taken right after freeze drying (Day 1).

TABLE 3

| | Sample | Water | Moisture |
|---|---|---|---|
| Sample ID | Description | Activity (a_{w}) | (%) |
| Ground Chicken + Prob + Salm | Top Tray | 0.05 | 0.50 |
| Ground Chicken + Prob + Salm | Middle Up Tray | 0.04 | 0.80 |
| Ground Chicken + Prob + Salm | Middle Down Tray | 0.05 | 0.90 |
| Ground Chicken + Prob + Salm | Bottom Tray | 0.08 | 1.00 |
| Ground Chicken + Salm | Top Tray | 0.04 | 0.70 |
| Ground Chicken + Salm | Middle Up Tray | 0.05 | 0.90 |
| Ground Chicken + Salm | Middle Down Tray | 0.04 | 0.80 |
| Ground Chicken + Salm | Bottom Tray | 0.05 | 1.30 |

Table 4 illustrates the total probiotic organisms present after the freeze-drying procedure in samples collected at specified intervals over the 35-day storage period. On average, the freeze-drying process reduced the probiotic concentration by 1.35 log₁₀ CFU/g.

TABLE 4

| | | | | Total probiotic | |
|---|---|---|---|---|---|
| Storage | Salmonella | | | organisms | Log₁₀ |
| Time | PCR¹ | X-Test | Sample | after freeze- | reduction |
| (DAY) | Postives | (Black) | Description | drying (CFU/g) | (CFU/g) |
| 1 | 1 | 1 | Chicken + Probiotic | 4.9 × 10⁵ | 1.35 |
| | | | + Salmonella | | |
| 1 | 3 | 3 | Chicken + Salmonella | — | — |
| 3 | 2 | 3 | Chicken + Probiotic | 4.7 × 10⁵ | 1.37 |
| | | | + Salmonella | | |
| 3 | 3 | 3 | Chicken + Salmonella | — | — |
| 5 | 1 | 1 | Chicken + Probiotic | 5.0 × 10⁵ | 1.34 |
| | | | + Salmonella | | |
| 5 | 3 | 3 | Chicken + Salmonella | — | — |
| 7 | 0 | 0 | Chicken + Probiotic | 4.6 × 10⁵ | 1.38 |
| | | | + Salmonella | | |
| 7 | 3 | 3 | Chicken + Salmonella | — | — |
| 10 | 0 | 0 | Chicken + Probiotic | 4.2 × 10⁵ | 1.42 |
| | | | + Salmonella | | |
| 10 | 2 | 2 | Chicken + Salmonella | — | — |
| 14 | 0 | 0 | Chicken + Probiotic | 3.9 × 10⁵ | 1.45 |
| | | | + Salmonella | | |
| 14 | 2 | 2 | Chicken + Salmonella | — | — |
| 21 | 0 | 0 | Chicken + Probiotic | 4.3 × 10⁵ | 1.41 |
| | | | Salmonella | | |
| 21 | 3 | 3 | Chicken + Salmonella | — | — |
| 28 | 0 | 0 | Chicken + Probiotic | 4.1 × 10⁵ | 1.43 |
| | | | + Salmonella | | |
| 28 | 3 | 3 | Chicken + Salmonella | — | — |
| 35 | 0 | 0 | Chicken + Probiotic | 3.8 × 10⁵ | 1.46 |
| | | | + Salmonella | | |
| 35 | 2 | 2 | Chicken + Salmonella | — | — |

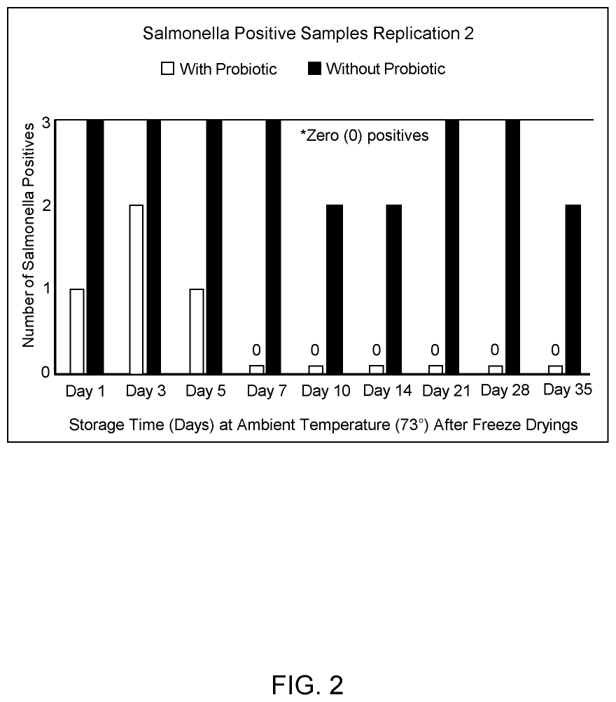

As shown in FIG. 2, at Day 1, only one of the samples inoculated with both the Salmonella and probiotic composition tested positive for Salmonella, in contrast two of the three samples inoculated with Salmonella only (i.e. no probiotic composition) tested positive for Salmonella. Further, this trend continued until Day 7. At Day 7, none of the samples treated with the probiotic composition tested positive for Salmonella. This trend continued up to Day 35 of testing. The control samples containing only Salmonella continued to test positive up to Day 35, whereas the samples treated with the probiotic composition did not test positive for Salmonella starting at Day 7 and continuing out until Day 35. The addition of the probiotic resulted in no samples that were entirely enriched for Salmonella testing positive. All of the samples that contained NO probiotic were entirely enriched for Salmonella spp., and they continued to remain positive over the entire 35 day of storage.

Replication 3: Samples of raw chicken product were inoculated with Salmonella. Of those samples, three (3) were selected and a probiotic composition was applied prior to subjecting the samples to a freeze-drying process. The probiotic composition was applied in an amount of 1.0×10⁷ CFU/gram of raw chicken product. The remaining product was then subjected to a freeze-drying process. Table 5 illustrates the Water Activity (A_{w}) and Moisture (%) of the samples taken on Day 1 after freeze-drying.

TABLE 5

| | Sample | Water | Moisture |
|---|---|---|---|
| Sample ID | Description | Activity (a_{w}) | (%) |
| Ground Chicken + Prob + Salm | Top Tray | 0.04 | 0.45 |
| Ground Chicken + Prob + Salm | Middle Up Tray | 0.05 | 0.66 |
| Ground Chicken + Prob + Salm | Middle Down Tray | 0.05 | 0.83 |
| Ground Chicken + Prob + Salm | Bottom Tray | 0.08 | 1.18 |
| Ground Chicken + Salm | Top Tray | 0.04 | 0.55 |
| Ground Chicken + Salm | Middle Up Tray | 0.06 | 0.82 |
| Ground Chicken + Salm | Middle Down Tray | 0.05 | 0.68 |
| Ground Chicken + Salm | Bottom Tray | 0.10 | 1.82 |

Table 6 illustrates the total probiotic organisms present after the freeze-drying procedure (at Day 1 through Day 35) and the logio reduction of probiotic organisms (at Day 1 through Day 35). On average, the freeze-drying process resulted in approximately 1.36 log₁₀ CFU/g reduction in probiotic numbers. The inoculum and freeze-dried concentration (CFU/g) of probiotics were consistent for all 3 replications.

TABLE 6

| | | | | Total probiotic | |
|---|---|---|---|---|---|
| Storage | Salmonella | | | organisms | Log₁₀ |
| Time | PCR¹ | X-Test | Sample | after freeze- | reduction |
| (DAY) | Postives | (Black) | Description | drying (CFU/g) | (CFU/g) |
| 1 | 1 | 1 | Chicken + Probiotic | 4.5 × 10⁵ | 1.35 |
| | | | + Salmonella | | |
| 1 | 3 | 3 | Chicken + Salmonella | — | — |
| 3 | 1 | 1 | Chicken + Probiotic | 4.3 × 10⁵ | 1.37 |
| | | | + Salmonella | | |
| 3 | 3 | 3 | Chicken + Salmonella | — | — |
| 5 | 0 | 0 | Chicken + Probiotic | 3.8 × 10⁵ | 1.42 |
| | | | + Salmonella | | |
| 5 | 2 | 2 | Chicken + Salmonella | — | — |
| 7 | 0 | 0 | Chicken + Probiotic | 4.1 × 10⁵ | 1.39 |
| | | | + Salmonella | | |
| 7 | 3 | 3 | Chicken + Salmonella | — | — |
| 10 | 0 | 0 | Chicken + Probiotic | 4.6 × 10⁵ | 1.34 |
| | | | + Salmonella | | |
| 10 | 3 | 3 | Chicken + Salmonella | — | — |
| 14 | 0 | 0 | Chicken + Probiotic | 4.4 × 10⁵ | 1.36 |
| | | | + Salmonella | | |
| 14 | 3 | 3 | Chicken + Salmonella | — | — |
| 21 | 0 | 0 | Chicken + Probiotic | 3.9 × 10⁵ | 1.41 |
| | | | + Salmonella | | |
| 21 | 2 | 2 | Chicken + Salmonella | — | — |
| 28 | 0 | 0 | Chicken + Probiotic | 4 × 10⁵ | 1.40 |
| | | | + Salmonella | | |
| 28 | 2 | 2 | Chicken + Salmonella | — | — |
| 35 | 0 | 0 | Chicken + Probiotic | 3.8 × 10⁵ | 1.42 |
| | | | + Salmonella | | |
| 35 | 2 | 2 | Chicken + Salmonella | — | — |

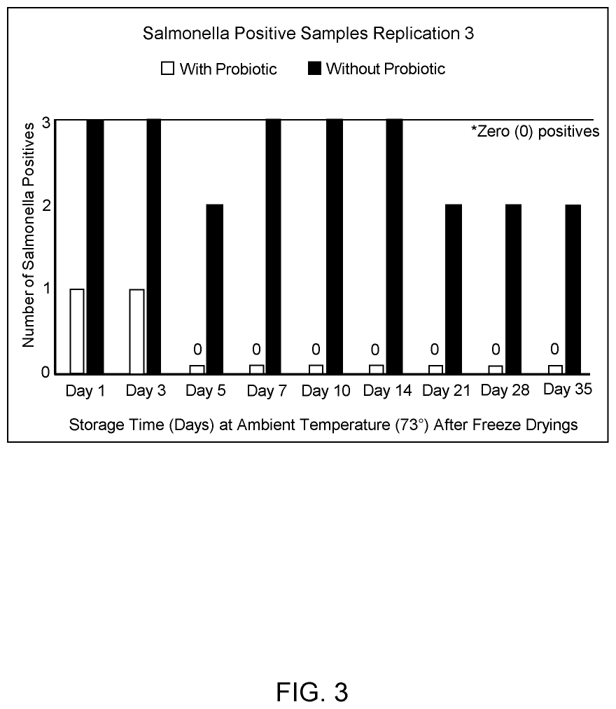

As shown in FIG. 3, at Day 1, only one of the samples inoculated with both the Salmonella and probiotic composition tested positive for Salmonella, in contrast two of the three samples inoculated with Salmonella only (i.e. no probiotic composition) tested positive for Salmonella. Further, this trend continued until Day 5. At Day 5, none of the samples treated with the probiotic composition tested positive for Salmonella. This trend continued up through Day 35. The control samples containing only Salmonella (NO probiotic) continued to test positive for Salmonella up through Day 35, whereas the samples treated with the probiotic composition did not test positive for Salmonella starting at Day 5 and continuing out until Day 35.

Comparing Replications 1-3, the chicken that was treated with probiotics and freeze-dried had repeatable reductions (from 66% to 100%) of pathogens starting on Day 1 (66% reduction) with all pathogen inhibited by Day 5 or at the latest, Day 7 (100% reduction) after freeze-drying as compared to the chicken that was not treated with probiotics. The freeze-dried chicken that was not coated with the probiotic composition continued to test positive for certain pathogens, i.e. Salmonella, up to 35 days after freeze-drying of the chicken. Accordingly, coating the chicken with the probiotic composition and freeze-drying the chicken effectively reduced the pathogen load of the chicken despite the differences in freeze-drying parameters. These results were consistent despite any potential differences in the time/temperature freeze-drying procedures. All three replications were done on different days and all treatment combinations were placed into freeze dryers in a completely randomized design. Variability in results between the product with probiotics and product with NO probiotics is due to the probiotic itself coupled with freeze drying.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

Although embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. For example, while methods for the production of a food product made according to those methods have been exemplified, other uses are contemplated. Therefore, the spirit and scope of the appended claims should not be limited to the description of the versions contained therein.

What is claimed is:

1. A method of freeze-drying a food product, comprising the steps of:
a. applying a probiotic composition to the food product creating a probiotic composition-containing food product; and
b. subjecting the probiotic composition-containing food product to at least one freeze-drying procedure creating a probiotic composition-containing freeze-dried food product.

2. The method of claim 1, wherein the probiotic composition comprises at least one biosurfactant-producing microorganism and at least one antiadhesion-producing microorganism.

3. The method of claim 2, wherein the at least one biosurfactant-producing microorganism is selected from the group consisting of Lactobacillus acidophilus, Lactobacillus casei, Lactobacillus paracasei, Lactobacillus fermentum, Lactobacillus lactis, Lactobacillus reuterii, Lactobacillus rhamnoses, Lactobacillus bulgaricus, Lactobacillus plantarum, Lactobacillus salivarius, Lactobacillus delbrueckii, Lactobacillus Lactobacillus helveticus, Lactobacillus brevis, Lactobacillus sakei, Lactobacillus johnsonii, Bifidobacterium longum, Bifidobacterium bifidum, Bifidobacterium breve, Bifidobacterium infantis, Bifidobacterium adolecentis, Bifidobacterium lactis, Bifidobacterium animalis, Enterococcus faecium, and combinations thereof.

4. The method of claim 2, wherein the at least one antiadhesion-producing microorganism is selected from the group consisting of Lactobacillus acidophilus, Lactobacillus casei, Lactobacillus paracasei, Lactobacillus fermentum, Lactobacillus lactis, Lactobacillus reuterii, Lactobacillus rhamnoses, Lactobacillus bulgaricus, Lactobacillus plantarum, Lactobacillus salivarius, Lactobacillus delbrueckii, Lactobacillus helveticus, Lactobacillus brevis, Lactobacillus sakei, Lactobacillus johnsonii, Bifidobacterium longum, Bifidobacterium bifidum, Bifidobacterium breve, Bifidobacterium infantis, Bifidobacterium adolecentis, Bifidobacterium lactis, Bifidobacterium animalis, Enterococcus faecium, and combinations thereof.

5. The method of claim 1, wherein the probiotic composition is present in an amount of from about 10² to about 10¹¹ colony forming units per gram of the food product.

6. The method of claim 1, wherein the probiotic composition comprises microorganisms that are certified as generally recognized as safe.

7. The method of claim 1, wherein the food product comprise a meat product.

8. The method of claim 1, wherein the food product comprises a vegetable or fruit product.

9. A method of treating a food product to inhibit the growth of a pathogen thereon, the method comprising the step of:
a. applying a probiotic composition to the food product surface, and
b. freeze-drying the food product having the applied probiotic composition, wherein the probiotic composition inhibits the growth of at least one pathogen on the food product surface.

10. The method of claim 9, wherein the probiotic composition comprises at least one microorganism selected from the group consisting of Lactobacillus acidophilus, Lactobacillus casei, Lactobacillus paracasei, Lactobacillus fermentum, Lactobacillus lactis, Lactobacillus reuterii, Lactobacillus rhamnoses, Lactobacillus bulgaricus, Lactobacillus plantarum, Lactobacillus salivarius, Lactobacillus delbrueckii, Lactobacillus helveticus, Lactobacillus brevis, Lactobacillus sakei, Lactobacillus johnsonii, Bifidobacterium longum, Bifidobacterium bifidum, Bifidobacterium breve, Bifidobacterium infantis, Bifidobacterium adolecentis, Bifidobacterium lactis, Bifidobacterium animalis, Enterococcus faecium, and combinations thereof.

11. The method of claim 9, wherein the at least one pathogen is selected from the group consisting of Salmonella.

12. The method of claim 9, wherein the probiotic composition is applied to the food product in an amount of from about 10² to about 10¹¹ colony forming units per gram of the food product.

13. The method of claim 9, wherein the probiotic composition is certified generally recognized as safe (GRAS).
